(19) United States
(12) Patent Application Publication
(10) Pub. No.: US 2024/0118372 A1
(43) Pub. Date: Apr. 11, 2024

(54) METHODS AND APPARATUS FOR ASCERTAINING LOCATIONS OF UNKNOWN RADIO FREQUENCY EMITTERS USING SOFTWARE DEFINED RADIO (SDR) AMPLITUDE MEASUREMENTS

(71) Applicant: The United States of America, as represented by the Secretary of the Navy, Crane, IN (US)

(72) Inventors: Ryan Loehrlein, Bloomington, IN (US); Timothy Ringwald, Loogootee, IN (US); Kimberly Gold, Nashville, TN (US); Jeffrey A. Miller, Bloomington, IN (US)

(73) Assignee: The United States of America, as represented by the Secretary of the Navy, Arlington, VA (US)

(21) Appl. No.: 18/227,728

(22) Filed: Jul. 28, 2023

Related U.S. Application Data
(60) Provisional application No. 63/393,070, filed on Jul. 28, 2022.

(51) Int. Cl. G01S 5/02; G06T 11/20

(52) U.S. Cl. CPC G01S 5/02524; G01S 5/02527; G06T 11/206

(57) ABSTRACT

Disclosed are methods and apparatus for recording time, latitude, longitude, frequency, and amplitude data to ascertain information about the radio frequency (RF) environment (e.g., RF emitter locations), where the apparatus is also easily transportable. The location determination method using this simple hardware solution may occur in two processes or phases: (1) a data collection phase; and (2) a data processing phase, although these two phases may also be combined in time for a real time solution. During the data collection phase, a user may select a desired frequency range and step size for analysis. A software defined radio (SDR) sweeps through the desired frequencies and records the amplitude associated with each frequency. Each of the recorded points are stamped with their time and geolocation (i.e., latitude and longitude coordinates) and processed using amplitude measurements to ascertain the locations of unknown emitters.

### CROSS REFERENCE TO RELATED APPLICATIONS

The present application claims the benefit of and priority to U.S. Provisional Application Ser. No. 63/393,070 filed on Jul. 28, 2022, the disclosure of which is expressly incorporated herein by reference.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 210865US02) is assigned to the United States Government and is available for licensing for commercial purposes. Licensing and technical inquiries may be directed to the Technology Transfer Office, Naval Surface Warfare Center Crane, email: Cran_T2@navy.mil.

### FIELD

The present disclosure generally relates to methods and apparatus for determining the location of radio frequency (RF) emitters, and more particularly to determining the location of unknown RF emitters based on, among other things, software defined radio (SDR) amplitude measurements.

### BACKGROUND

In applications such as electronic warfare systems, it may be desirable to be able to determine a geospatial position or location of unknown radio frequency (RF) emitters. Known apparatus and methods for determining the position of an unknown emitter typically require multiple sensors (e.g., multiple receivers), specialized antennas, and sophisticated algorithms. These setups are typically very expensive and not easily transportable. Furthermore, determination of an RF emitter position using simple measurements such as amplitude measurements, for example, has not been a previously known option for passively determining RF emitter locations.

### SUMMARY

The presently disclosed invention is capable of leveraging a simple hardware solution to record time, latitude, longitude, frequency, and amplitude data to ascertain information about the RF environment that is also easily transportable. The location determination method using this hardware solution may occur in two processes or phases: (1) a data collection phase; and (2) a data processing phase, although these two phases may also be combined in time for a real time solution. During the data collection phase, the user can select the frequency range and step size that they would like to analyze. A software defined radio (SDR) sweeps through the desired frequencies and records the amplitude associated with each frequency. Each of the recorded points are stamped with their time and geolocation (i.e., latitude and longitude coordinates). The recorded data then is processed using, among other things, SDR amplitude measurements to ascertain the locations of unknown emitters in the data processing phase or process.

In further aspects, the present disclosure provides an apparatus for determining locations of radio frequency emitters. The apparatus includes at least one software defined radio (SDR) configured to collect radio frequency (RF) emission information by sweeping through one or more RF frequencies and recording RF signal amplitudes sensed for each of the one or more RF frequencies and recording geolocations and time stamps associated with each recorded RF signal amplitude. Furthermore, the apparatus includes at least one processor configured to process the collected RF emission information to determine locations of one or more RF emitter based on the recorded signal amplitudes, geolocations, and time stamps.

In yet further aspects, the present disclosure provides a method for determining locations of radio frequency emitters. The method includes collecting radio frequency (RF) emission information by sweeping through one or more RF frequencies with an SDR and recording RF signal amplitude sensed for each of the one or more RF frequencies and recording geolocations and time stamps associated with each recorded RF signal amplitude. Furthermore, the method includes processing the collected RF emission information to determine locations of one or more RF emitter based on the recorded signal amplitudes, geolocations, and time stamps as shown in block 2104.

In still further aspects, the present disclosure includes a computer-readable medium storing computer executable code, wherein the code when executed by at least one processor causes the at least one processor to (1) collect radio frequency (RF) emission information with at least one software defined radio (SDR) for determining locations of one or more unknown RF emitters by sweeping through one or more RF frequencies and recording RF signal amplitude sensed for each of the one or more RF frequencies and recording geolocations and time stamps associated with each recorded RF signal amplitude; and (2) process the collected RF emission information to determine locations of the one or more unknown RF emitters based on the recorded signal amplitudes, geolocations, and time stamps.

### BRIEF DESCRIPTION OF THE DRAWINGS

The detailed description of the drawings particularly refers to the accompanying figures in which:

FIG. 1 shows a block diagram of an exemplary apparatus for determining an RF emitter location according to aspects of the present disclosure.

FIG. 2 shows a plot of signal amplitude over a portion or range of positional locations (i.e., latitudes) according to aspects of the present disclosure.

FIG. 3 shows a plot of signal amplitude over a portion or range of positional locations (i.e., latitudes) according to aspects of the present disclosure.

FIG. 4 shows a three-dimensional plot of latitude, longitude, and amplitude readings of an RF environment according to aspects of the present disclosure.

FIG. 5 shows a plot of data points of a data path/max amplitude displayed for various longitudes and latitudes according to aspects of the present disclosure.

FIG. 6 shows a two-dimensional RF environment heat map based on collected data over various according to aspects of the present disclosure.

FIG. 7 shows a three-dimensional RF environment heat map plot of latitude, longitude, and amplitude readings according to aspects of the present disclosure.

FIG. 8 shows a three-dimensional RF environment heat map plot of latitude, longitude, and amplitude readings after application of a K-means clustering process according to aspects of the present disclosure.

FIG. 9 shows a three-dimensional plot of transmission power from recorded points to grid points over latitude, longitude, and amplitude readings according to aspects of the present disclosure.

FIG. 10 shows another three-dimensional plot of transmission power from recorded points to grid points over latitude, longitude, and amplitude readings according to aspects of the present disclosure.

FIG. 11 shows another three-dimensional plot of transmission power from recorded points to grid points over latitude, longitude, and amplitude readings according to aspects of the present disclosure.

FIG. 12 shows another three-dimensional plot of transmission power from recorded points to grid points over latitude, longitude, and amplitude readings according to aspects of the present disclosure.

FIG. 13 shows another three-dimensional plot of transmission power from recorded points to grid points over latitude, longitude, and amplitude readings according to aspects of the present disclosure.

FIG. 14 shows another three-dimensional plot of transmission power from recorded points to grid points over latitude, longitude, and amplitude readings according to aspects of the present disclosure.

FIG. 15 shows another three-dimensional plot of transmission power from recorded points to grid points over latitude, longitude, and amplitude readings according to aspects of the present disclosure.

FIG. 16 shows another three-dimensional plot of transmission power from recorded points to grid points over latitude, longitude, and amplitude readings according to aspects of the present disclosure.

FIG. 17 shows another three-dimensional plot of transmission power from recorded points to grid points over latitude, longitude, and amplitude readings according to aspects of the present disclosure.

FIG. 18 shows a three-dimensional plot of average transmission power from recorded points to grid points over latitude, longitude, and amplitude readings according to aspects of the present disclosure.

FIG. 19 shows a three-dimensional plot of an all recorded points averaged difference matrix over latitude, longitude, and amplitude readings according to aspects of the present disclosure.

FIG. 20 shows an exemplary method for determining RF emitter locations according to some aspects of the disclosure.

FIG. 21 illustrates another exemplary method for determining RF emitter locations according to some aspects of the disclosure.

### DETAILED DESCRIPTION OF THE DRAWINGS

The embodiments of the invention described herein are not intended to be exhaustive or to limit the invention to the precise forms disclosed. Rather, the embodiments selected for description have been chosen to enable one skilled in the art to practice the invention.

As mentioned above, amplitude measurements have not previously been a viable option for passively determining an RF emitter's location. The present invention allows for a user to determine the location of an emitter from amplitude measurements, such as SDR amplitude measurements as an example. The disclosed apparatus and methods utilize a different approach to the RF spectrum awareness problem, utilizes easy visualization, provides RF “HeatMap” graphics that display and get the information into a format that a user can readily and easily interpret.

The present invention is capable of leveraging a simple hardware solution to record time, latitude, longitude, frequency, and amplitude data to ascertain information about the RF environment. This process occurs in two separate phases: (1) the data collection phase; and (2) the data processing phase. In some embodiments, these two phases may be combined for a real time solution.

During the data collection phase the user can select the frequency range and step size that they would like to analyze. A Software Defined Radio (SDR) will sweep through desired one or more frequencies and records the RF amplitude associated with each selected or desired frequency. Furthermore, each of the recorded points are stamped or stored with their time and geolocation (i.e., Latitude and Longitude measurements).

In the data processing phase the recorded data is then processed via a script, such as a MATLAB script as one example, that is capable of importing, sorting, and cleaning the data to eliminate any unforeseen errors associated with the data collection. Once the data has been processed, the script pre-allocates memory via M-by-N matrixes (determined during the importing/sorting/cleaning phase) to eliminate excess computational time. The script then creates a meshed grid of the recorded latitude and longitude values to establish grid vectors. This creates a boundary condition that is leveraged to produce the coordinates of a rectangular grid (X, Y) based on the maximum/minimum recorded latitude/longitude values. The grid data, in conjunction with the latitude, longitude, and amplitude values, are then imported into a natural neighbor interpolation function. The interpolation function allows the script to calculate realistic data at each of the grid vectors based on the recorded dataset (i.e. increasing the number of points within the dataset to get higher fidelity). The interpolation function creates a mesh grid (X-Latitude, Y-Longitude) with an intensity value (Z-Amplitude) to produce a 2-Dimensional and 3-Dimensional representation of the recorded data. Everything depicted above are the initial conditions and calculations required to ascertain the locations of unknown emitters via the SDR amplitude measurements.

Once the initial conditions have been calculated, the script then utilizes a k-means clustering algorithm to further sort or organize the data. The clustering algorithm is designed to help determine “hot” spots within the dataset (i.e. clusters or zones in which the amplitude is similar across a 3-Dimensional space). Currently, the k-means clustering algorithm color coordinates the data into distinctive clusters (preset to only compute five clusters) and calculates each of the clusters centroid. The centroid is then plotted on a 2D and 3D plot to help ascertain an emitter's location. The centroid will provide a user with a confidence interval on where the unknown emitter is located, however, this is a rudimentary method of determining the exact location. The centroids are then plotted against the initial intensity plots (i.e. the initial conditions or recorded data) to cross-correlate the data to see if there are any trends. This typically results in one or two zones in which the emitter may be located within.

The script then executes the most advanced or “innovative” calculation scheme to ascertain the unknown emitter location. Due to memory constraints the code structure strategically chooses an “x” number of recorded data points (e.g., 5 to 10). These data points consist of the minimum, average, and maximum amplitude values (with their corresponding latitude and longitude information) and randomly selected data points in between these boundary conditions. These points are then used to create X number of M-by-N distance matrixes. These distance matrixes use the law of haversine to calculate the selected data points distance between the mesh grids (i.e. latitude and longitude boundary conditions) calculated in the first phase of the MATLAB script. Once the distances are calculated the Free Space Path Loss (FSPL) equation is utilized to calculate the transmit power needed from the each of the grid points to obtain the received amplitude at the recorded data point. A 3D latitude, longitude, and Required Power surface plot is created for each of the X number of recorded data points. The M-by-N transmit power matrixes are then iteratively subtracted from each other. The absolute is taken of each sub-matrix to negate any negative amplitudes. All of the submatrices are then averaged to produce a single required power transmit plot. The final 3D surface plot will point to the unknown emitter's location. This plot shows the required power to obtain the recorded value across the entire gridded zone, the minimum amplitude (e.g., in dB) will be the zone in which the emitter is located. This information can then be cross correlated with the clustering algorithm zones and the initial conditions to fully verify that the location of the unknown emitters location.

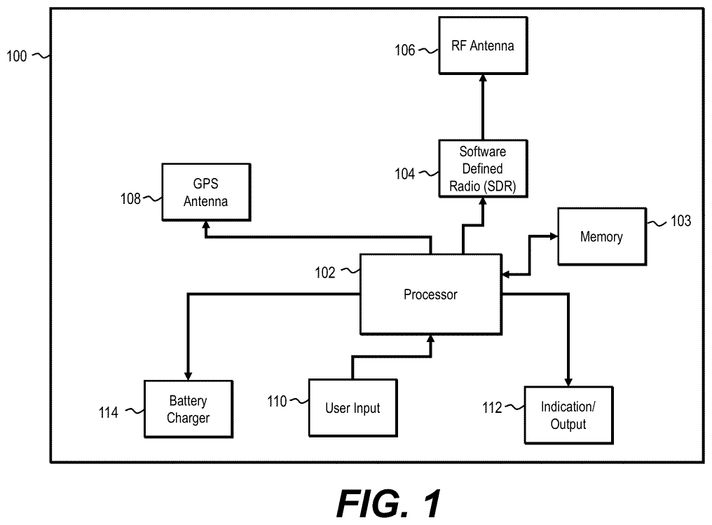

FIG. 1 illustrates an example block diagram of an apparatus 100 that is used for determining an RF environment (e.g., RF emitter locations) according to aspects of the present disclosure. The apparatus 100 may be a portable device and capable of being carried in a device such as a backpack or equivalent portable means. The apparatus 100 includes a processor 102, a memory or computer-readable medium 103, a software defined radio (SDR) module 104, an RF antenna 106, a GPS antenna, a user input interface 110, an output display or indication output (e.g., LED indicators), and a battery charger. In some implementations of apparatus 100, common devices such as commercial off the shelf (COTS) devices may be used for some or all of the elements in apparatus 100. For example, the processor 102 may be implemented with a Raspberry Pi processor, but is not limited to such. Further, the SDR module 104 may be implemented with software such as HackRf One software, but those skilled in the art will appreciate that SDR module 104 may be implemented with other hardware/firmware/software capable of measuring/detecting RF signal amplitude. Moreover, the antenna 106 may be implemented with an RH77CA antenna, but not limited to such.

Furthermore, the input interface 110 may be implemented with a touch screen, buttons, voice input, etc. The output indication 112 may be implemented with a display screen and/or light emitting diodes (LEDs) or any other suitable visual and/or audio communication means. Moreover, the battery charger may be a standard cell-phone type 5V charger is some implementations.

### Detailed Code Breakdown for Hardware (e.g., Software Defined Radio and Processor)

The code utilized for the SDR, such as implemented by 104 in FIG. 1, may be any source or object code. According to merely one example, but not limited to such, a python script shown below in Tables 1A and 1B effects scanning various frequencies, recording scanned RF environment, and recording geolocation (e.g., GPS packets (i.e. Latitude and Longitude)) along with time stamp information (e.g., date and time). This script also effects the output all of the recorded data into a single text file that may be be imported into a MATLAB code, for example, for post processing.

TABLE 1A
from gpiozero import Button as BD, LED
from gps3 import gps3
from tkinter import *
from tkinter import filedialo
import pandas as pd
import subprocess as term
from time import localtime, strftime
from time import sleep
################## Variables ###############
gps_socket = gps3.GPSDSocket( )
data_stream = gps3.DataStream( )
gps_socket.connect( )
gps_socket. watch( )
file_path = ‘/home/pi/Cyclops/GPS/’

| | |
|---|---|
| start_freq = int(422) | #Start Freq |
| stop_freq = int(522) | #Stop Freq |

```
duration = 2000
led = LED(12)
stop_button = BD(18)
###### Get GPS Location ############
def get_gps( ):
        for new_data in gps_socket:
          if new_data:
            data_stream.unpack(new_data)
            lon = data_stream.TPV[‘lon’]
            lat = data_stream.TPV[‘lat’]
            time1 = str(data_stream.TPV[‘time’])
            position = [time1, lat , lon ]
            if time1 == ‘n/a’:
              print(‘No GPS Signal’)
          else:
              print(‘New Position’)
              return position
def get_sweep( ): # Get sweeps from Hack
    term.call(‘hackrf_sweep -f ’ + str(start_freq) + ‘:’ + str(
      stop_freq) + ‘ >> ’ + file_path + file_name + -w 2500000 -l 24 -g 32 −1’,
shell=True)
    TempLog = pd.read_csv(file_path + file_name, header=None) # Read file.
    term.call(‘rm ’ + file_path + file_name, shell=True)
    TempLog.sort_values(by=[2], inplace=True) # Corrects freq shuffle.
    TempLog.columns = [‘Date’ , ‘Time’ , ‘Freq_Start’ , ‘Freq_Stop’ , ‘Bin’ , ‘Sample’ ,
‘Amp1’ , ‘Amp2’ , ‘Amp3’]
  del TempLog[‘Date’] del TempLog[‘Time’] del TempLog[‘Bin’] del TempLog[‘Sample’]
  del TempLog[‘Freq_Stop’]
    TempLog.drop_duplicates(subset = ‘Freq_Start’, keep = FIRST , inplace = True)
    ver_len = len(TempLog)
    for i in range(ver_len):
      x = int((TempLog.iloc[i , 1] + TempLog.iloc[i , 2] + TempLog.iloc[i , 3])/3)
  TempLog.iloc[i , 1] = x del TempLog[‘Amp2’]
  del TempLog[‘Amp3’]
  TempLog = TempLog.astype(int)
  freq_list = TempLog[‘Freq_Start’].tolist( )
  amp_list = TempLog[‘Ampl’].tolist( )
  final_list = freq_list + amp_list
  final_list[::2] = freq_list
  final_list[1::2] = amp_list
  return final_list
```

```
TABLE 1B
def stop( ):
  print(‘stopping’)
  sleep(1) # wait for the hold time we want.
    if stop_button.is_pressed: #check if the user let go of the button
        new_i = 0
        for i in range(10):
            led.on( )
            sleep(.12)
            led.off( )
            sleep(.12)
  print(new_i)
  return new_i
######## Main Program ##############################################
for i in range(duration):
    led.on( )
    place = get_gps( )
    print(i)
    if i == 0;
        t_now = time = strftime(‘%Y%m%d_%H%M’, localtime( ))
        file_name = str(t_now)
    rf_list = get_sweep( )
    led.off( )
    sleep(.25)
    place.extend(rf_list)
    total_info = pd.DataFrame(place)
    total_info = total_info.T
    total_info.to_csv(file_path + file_name +‘.txt’, mode =‘a’ , header=False,
index=False)
      if stop_button.is_pressed:
          i = stop( )
          t_now = place[0]
          file_name = str(t_now)
          print(“returned from stop = ” + str(i))
      place = 0
```

In an example using MATLAB, various processes are implemented including Data Importing Processes, External Data Variable Separation, Selecting desired Frequency, Processing the DataSet, Plotting Methods, Defining the GeoTiff and Keyhole Markup Language (KML) Files Naming Convention, Exporting/Creating the GeoTiff and KML Files, and other advanced calculations.

The following exemplary code shown in TABLE 2 effectuates launch of a User Interface that allows a user to select the appropriate data file needed to be analyzed. The file will automatically be read into MATLAB and converted to dynamic variables based on the column headers. The code is designed to work with at least the following file extensions .txt, .csv, or .xls.

```
TABLE 2
% When data is imported into MATLAB, the variable names (i.e. Column Header
% will be modified if they contain invalid properties (i.e. spaces, dashes,
% forward slashes, or back slashes). These variables will then be
% manipulated and classified under the appropriate variable style, however,
% the original names will be saved in the VariableDescriptions property.
[file,path,~] = uigetfile({‘*.*’;‘*.m’}, ‘File Selector‘);
if isequal(file,0)
  disp(‘User selected Cancel’) % An error message will appear if the UI
        % dialogue prompt is closed or canceled
else
  [fPath, fName, fExt] = fileparts(file);
  % The fileparts function returns the path name, file name, and
  % extension for the specified file. fileparts only parses the specified
  % filename. It does not verify that the file exists.
  switch lower(fExt
      case ‘.csv’ % MATLAB Reads Data from a CSV (.csv) file
          T = readtable(strcat(path,fName));
          Parser = 1;
      case ‘.txt’ % MATLAB Reads Data from a Text (.txt) File
          T = readtable(strcat(path,fName))
          Parser = 2;
      case ‘.xlsx’ % MATLAB Reads Data from an Excel Spreadsheet (.xlsx)
          T = readtable(strcat(path,fName));
          Parser = 3;
      case ‘’ % MATLAB Reads Data from User System
          T = readtable(strcat(path,fName));
          Parser = 4;
      otherwise % Under all circumstances SWITCH gets an OTHERWISE!
          error(‘Unexpected file extension: %s’, fExt);
          Parser =0; %#ok<UNRCH>
  end disp([‘User selected ’, fullfile(path, file)])
  % The fullfile function returns a character vector containing the full
  % path to the file. On Windows ® platforms, the file separator character
  % is a backslash (\).
end
% The functionality below removes any information that is invalid such as
% NaN, N/a, −99, NA, etc. The data is removed and the user is prompted
% which rows are being removed from the dataset.
TF = ismissing(T,{‘’ ‘.’ ‘NA’ ‘n/a’ NaN −99});
rowsWithMissing = T(any(TF,2),:); [row_freq_Missing,col_freq_Missing]=find(TF==1);
disp((‘The following Rows/Columns have missing data:’))
disp([row_freq_Missing,col_freq_Missing]) disp([‘These Rows have been removed from
calculations, please check‘... ’
  your data to ensure it is complete’])
[C,ia,ic] = unique(row_freq_Missing(:,1));
a_counts = accumarray(ic,1);
value_counts = [C, a_counts];
for i=1:1:length(C)
    TF = ismissing(T,{‘’ ‘.’ ‘NA’ ‘n/a’ NaN −99});
    [rowe,cole] = find(TF==1);
    T(rowe(1),:) = [ ];
end
% disp(rowsWithMissing)
```

The data that the system creates will be in a predetermined format. The length of the data can vary depending on the scanned frequencies. However, the first three columns will be consistent. The data will follow the following TABLE 3.

```
TABLE 3
%   Var1  |  Var2  |  Var3  |  Var4  |  Var5  |  VarN  |  VarN
%  - - - - - - - - - - - - - - - - - - - - - - - - - - - - - - - - - - - - - - - - - - - - - - - - - - - - -
%  Time  |  lat  |  Long  |  Freq1  |  Amp  |  FreqN  |  AmpN
% Variable 4 (Frequency) and Variable 5 (Amplitude) repeat until the
% frequency scan is completed. The first three columns (i.e. Var1, Var2,
% Var3) will always be Time ('YYYY-MM-DDTHH:MM:SS.000Z'), Latitude (Decimal
% Degrees), and Longitude (Decimal Degrees).
% Before running the for loop the variable called VarNames is getting
% a pre-allocated block of memory for x column headers by initializing the
% cell array. The Cell function (example cell([M,N]) is an M-by-N array of
% empty matrices for memory allocation. The Code will execute faster
% because there is no need to repeatedly reallocate memory for the
% growing structure.
Frequency=cell(1, (size(T,2)-3)/2);
Amplitude=cell(1, (size(T,2)-3)/2);
Freq=ones(size(T,1),(size(T,2)-3)/2,'int8');
Amp=ones(size(T,1),(size(T,2)-3)/2,'int8');
% The code below will separate the data into the correct variables.
if ischar(T.Properties.VariableNames{1})==1 | | . . .
    T.Properties.VariableNames{1}=='Time'
  Time = T.(T.Properties.VariableNames{1});
  if iscell(T.(T.Properties.VariableNames{2}))==1
    Latitude = str2double(T.(T.Properties.VariableNames{2}));
  else
    Latitude = T.(T.Properties.VariableNames{2});
  end
  if iscell (T.(T.Properties.VariableNames{3}))==1
    Longitude = str2double(T.(T.Properties.VariableNames{3}));
  else
    Longitude = T.(T.Properties.VariableNames{3});
  end
  step = 0; Freq=[ ]; Amp=[ ];
  for DV=1:1:(size(T,2)-3)/2
    Frequency{DV}=(T.(T.Properties.VariableNames{4+step}));
    Amplitude{DV}=(T.(T.Properties.VariableNames(5+step}));
    Freq=[Freq Frequency{DV}]; %#ok<AGROW>
    Amp=[Amp Amplitude{DV}]; %#ok<AGROW>
    step = 2+step;
  end
else
end
```

For selecting desired frequency, a UI prompt may be implemented (e.g., indication at display 112 and ability to receive answer to prompt at input 110). This UI prompt will ask the user to input the desired frequency. The system then uses the desired frequency to determine its location in the matrix. If a user types in an invalid frequency the code will automatically create a list box for the user to select a valid frequency. In aspects, the selected frequency will be the frequency used for all calculations, plots, heat maps, kml files, and kmz files. An example code is shown in TABLE 4 below.

TABLE 4

```
prompt = {‘Frequency‘};
dlgtitle = ‘Frequency Selection’;
dims = [1 60];
definput = {strcat(num2str(Freq(1)),‘ [Units Hertz]’)};
Freq_Selction = inputdlg(prompt,dlgtitle,dims,definput);
if ismember(str2double(Freq_Selction{1}),Freq(1,:))==1
  [row_freq,col_freq]=(find(Freq(1,:)==(str2double(Freq_Selction{1}))));
else
  disp(strcat(‘You typed in an invalid Frequency.’,... ‘
    Please choose a correct Frequency from the list menu’))
  for 1st=1:1:length(Freq(1,:))
    list{1st}=strcat(num2str(Freq(1,lst)));
  end
  [indx_Freq,tf_Freq]=listdlg(‘ListString’,list,‘ListSize’,[300,150],...
    ‘Name’,‘Frequency Selection ’);
  [row_freq,col_freq] = (find(Freq(1,:)==(Freq(1,indx_Freq))));
end
Freq_MHz=Frequency{1,col_freq}(1)/1000000;
Freq_Hz=Frequency{1,col_freq}(1);
```

For processing the dataset, a meshgrid function ([X,Y]=meshgrid(xgv,ygv) replicates the grid vectors to produce the coordinates of a rectangular grid (X,Y). The grid vector xgv is replicated numel(ygv) times to form columns of X. The grid vector ygv is replicated numel(xgv) times to form rows of Y. The coordinate arrays are used for the evaluation of functions of two or three variables for surface and volumetric plots. Exemplary code for effecting this functionality is shown in TABLE 5 below.

```
TABLE 5
  North=max(Latitude);South= min(Latitude);
  East=max(Longitude);West=min(Longitude);
  [xi,yi] = meshgrid(min(Longitude):0.000001:max(Longitude),...
    min(Latitude):0.000001:max(Latitude));
  % The griddata function interpolates scattered data to produce gridded
  % data. The coordinates of the data points are defined by vectors
  % (Longitude, Latitude) and Amp defines the corresponding intensity values.
  % Griddata interpolates the surface at the query points and returns the
  % values in zi{HM}.
  % griddata(..., METHOD) where METHOD is one of the following variables
  % ‘nearest’ - Nearest neighbor interpolation
  % ‘linear’ - Linear interpolation (default)
  % ‘natural’ - Natural neighbor interpolation
  % ‘cubic’ - Cubic interpolation (2D only)
  % ‘v4’ - MATLAB 4 griddata method (2D only)
  % The ‘nearest’ and ‘linear’ methods have discontinuities in the zero-th
  % and first derivatives respectively,while the ‘cubic’ and ‘v4’ methods
  % produce smooth surfaces. All the methods except ‘v4’ are based on a
  % Delaunay triangulation of the data.
  for HM=1:1:size(Amp,2)
      zi{HM} = griddata(Longitude,Latitude,Amp(:,HM),xi,yi,‘natural’);
      %#ok<*SAGROW,*GRIDD>
      [max_num,max_idx] = max(Amp(:,HM));
      Amp_Max{HM}=max_num; Amp_Max_Idx(HM}=max_idx;
      Long_Amp_Max{HM}=Longitude(Amp_Max_Idx{HM});
      Lat_Amp_Max{HM}=Latitude(Amp_Max_Idx{HM});
  end
  % To further enhance the code (specifically identifying where an unknown
  % transmitter/emitter is located) a user can implement a clustering
  % algorithm into the script, shown below. Two codes structures that may be
  % beneficial in this would be the dbscan or kmeans clustering technique in
  % conjunction with the Elbow method. These are defined below:
  % Elbow Method: This method leverages a heuristic technique to determine
        % the number of clusters in a data set. The method plots the
        % explained variation as a function of the number of clusters
        % and picks the elbow of the curve (i.e. inflection point)
        % to determine the number of clusters to use. The technique
        % is beneficial for the kmeans and dbscan technique.
  % kmeans: k-means clustering is a method of vector quantization, originally
        % from signal processing, that aims to partition n
        % observations into k clusters in which each observation
        % belongs to the cluster with the nearest mean, serving as a
        % prototype of the cluster.
  % dbscan: Density-Based Spatial Clustering of Applications with Noise
        % (DBSCAN) of a data clustering non parametric algorithm:
        % given a set of points in a defined space, the algorithm
        % groups together points that are closely packed together
        % (i.e. neighbors), while creating outlier points that lie in
        % low density regions (whose nearest neighbors are too far
        % away).
  The kmeans clustering algorithm was used to examine the following
  % configurations:
    % Latitude vs Longitude vs Amplitude
% The main cluster analyzed can help identify where a hot zone (i.e.,
% transmitter/emitter) may be located. This also mitigates our current an
% approach only utilizing one calculation technique (i.e., interpolation)
% to predict where the transmitter is located. This approach
% increases confidence in where the unknown emitter is located and is
% also a novel/unique method to determine hot spots (i.e., amplitude intensity)
% via Radio Frequency Amplitude. This clustering technique is typically
% uncommon for RF analysis,
xi_km=reshape(xi‘,1,[ ])’;
yi_km=reshape(yi‘,1,[ ])’;
zi_km=reshape(zi{col_freq}‘,1,[ ])’;
kmeansdata=[xi_km,yi_km,zi_km];
[idx_km,Ckm]=kmeans(kmeansdata,5);
```

Further to the methodology implemented by the code shown in TABLE 5, it is noted that the kmeans clustering is performed based on a manual selection of the number of clusters to be generated, which can be problematic in some instances. To resolve this concern additional code implementing an elbow method may be employed to determine the optimal number of clusters. In an alternative, an evalclusters function may be utilized to create a clustering evaluation object containing data used to evaluate the optimal number of data clusters. The three clustering algorithms for evalclusters are kmeans, linkage, and gmdistribution. The four types of clustering evaluation criterion are “CalinskiHarabasz,” “DaviesBouldin,” “silhouette,” and “gap.” The output of the function provides an optimal number of clusters for a dataset based on the range the algorithm analyzed. The use of such optimization algorithms optimizes the code in TABLE 5 with the correct number of clusters the will engender even more accurate results (e.g., RF emitter locations). This is another novel and niche component associated with the code because the clustering algorithm is being enhanced, which is uncommon for RF analysis. As an example, the code in TABLE 5 may be adjusted using a one line adjustment as follows:
eva=evalclusters(kmeansdata, ‘kmeans’, ‘gap’, ‘KList’,[1:60]).

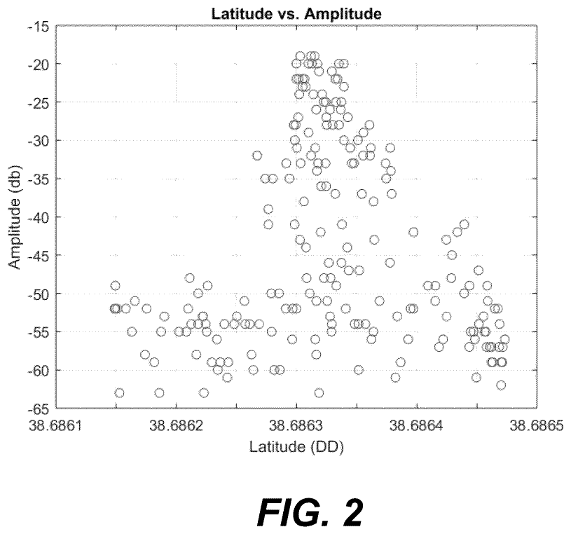

Further concerning plotting methods, FIG. 2 shows an example of a produced 2D plot showing the latitude (Decimal Degrees) versus the amplitude measurements associated with the chosen frequency. The visualization produced here helps rationalize the utilization of the clustering algorithm due to the visual “groupings.”

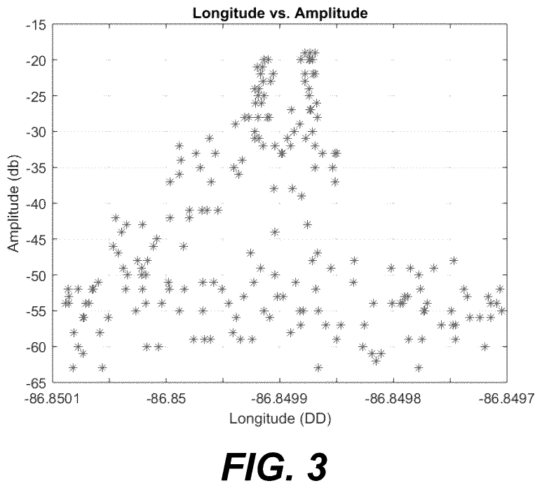

FIG. 3 produces a 2D plot showing the longitude (Decimal Degrees) versus the amplitude measurements associated with the chosen frequency. This visualization also helps rationalize the utilization of the clustering algorithm due to the visual “groupings.”

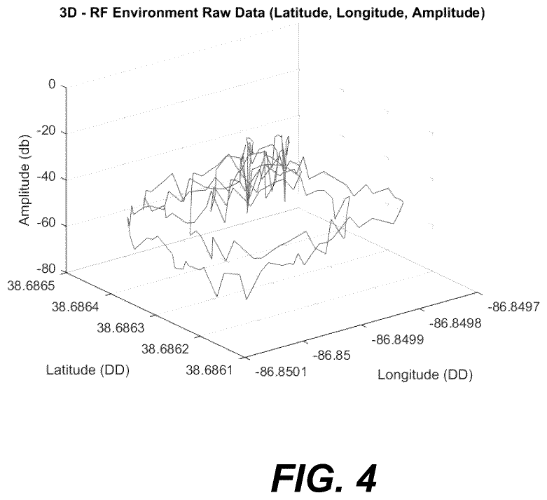

FIG. 4 shows an exemplary three-dimensional plot of latitude, longitude, and amplitude readings according to aspects of the present disclosure. In particular aspects, the present methods produces this three dimensional plot showing the latitude (Decimal Degrees) and longitude (Decimal Degrees) on the X and Y Axes versus the amplitude measurements on the Z axis for the frequency chosen for analysis. This visualization helps show where potential hotspots are located within the raw data (i.e., unprocessed amplitude data). This information also allows a user to see the path in which the receiver moved in a three dimensional space.

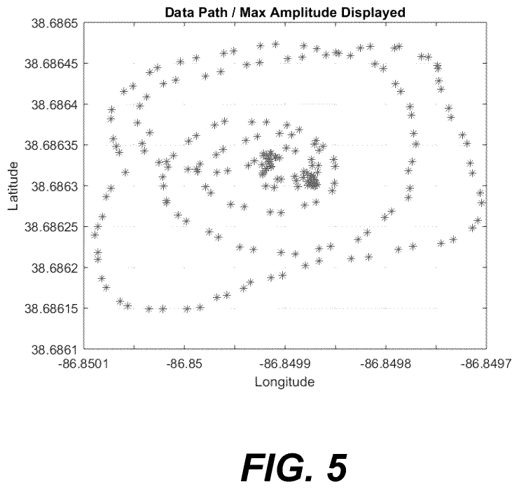

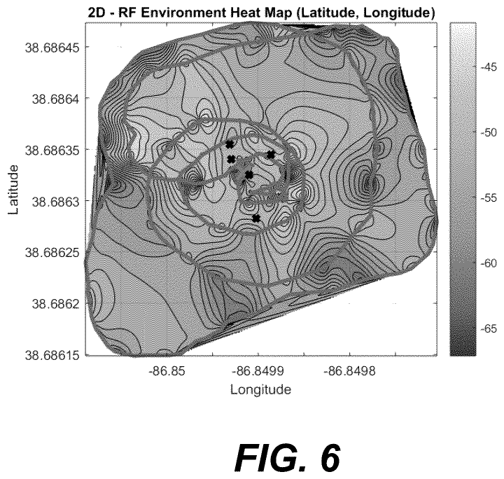

FIG. 5 shows an exemplary plot of data points of a data path/max amplitude displayed for various longitudes and latitudes according to aspects of the present disclosure. In particular aspects, the plot of FIG. 5 is a 2D plot showing the longitude (Decimal Degrees) and latitude (Decimal Degrees) on the respective X and Y Axes. This information allows a user to visualize the path in which the receiver moved from an “aerial” point of view (POV). This information also helps understanding/gain of situational awareness in conjunction with an RF heat map, which is illustrated in FIG. 6.

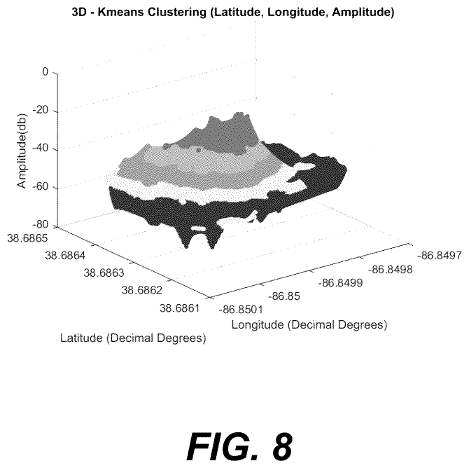

FIG. 6, in particular, shows an exemplary two-dimensional RF environment heat map based on collected data over various coordinates according to aspects of the present disclosure. In particular aspects, FIG. 6 is a 2D plot that is a combination of the data from FIG. 5 and FIG. 8 (i.e., clustering algorithm centroids as will be discussed later). This plot allows the user to understand the RF environment from an aerial POV. The color bar shown on the right side of the figure illustrates the interpolated intensity values across the meshed grid. These values indicate hot spots (i.e., topological perspective via the illustrated contour lines). The larger the number, the higher the recorded amplitude, which means an emitter could be within that boundary. The X's on the figure display the “centroids” from the clustering algorithm (discussed above). These represent zones that might have an emitter present therein.

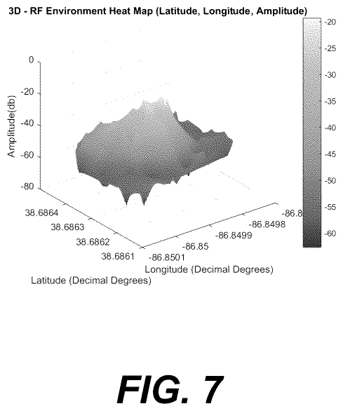

FIG. 7 shows a three-dimensional RF environment heat map plot of latitude, longitude, and amplitude readings according to aspects of the present disclosure. In particular aspects, FIG. 7 illustrates a 3D plot that is a combination of FIGS. 5, 6, and 8 (clustering algorithm centroids). This plot allows a user to understand the RF environment from a 3D POV. The color bar on the right side of the figure illustrates the interpolated intensity values across the meshed grid. These values indicate hot spots (i.e., topological perspective via contour lines). The larger the number, the higher the recorded amplitude, which means an emitter could be within that boundary. The X's on the plot display the “centroids” from the clustering algorithm and represent zones that might contain an emitter.

FIG. 8 shows a three-dimensional RF environment heat map plot of latitude, longitude, and amplitude readings after application of a K-means clustering process according to aspects of the present disclosure. In particular aspects, this figure illustrates a 3D heat map representation of the Kmeans clustering algorithm discussed earlier. Similar to the illustration discussed above, the plot may include s in the figure (not shown here) to display the “centroids” from the clustering algorithm and the distinct colors show how the algorithm has strategically clustered the amplitude measurements in conjunction with their geodetic position (i.e., latitude and longitudevalues).

The code shown in TABLE 6 below provides an exemplary code for implementing a plotting method for visualization as illustrated by FIGS. 2-8, but the invention is not limited to such. Examples of code used for each figure plotted are shown below.

```
TABLE 6
%Figure 2 plot
plot(Latitude,Amp(:,col_freq),‘o’); hold on; grid on
xlabel(‘Latitude (DD)’)
ylabel(‘Amplitude (db)’)
title(‘Latitude vs. Amplitude’) %
%Figure 3 plot
plot(Longitude,Amp(:,col_freq),‘*’); hold on; grid on
xlabel(‘Longitude (DD)’)
ylabel(‘Amplitude (db)’)
title(‘Longitude vs. Amplitude’)
% Figure 4 plot
plot3(Longitude, Latitude, Amp(:,col_freq)); grid on
xlabel(‘Longitude (DD)’)
ylabel(‘Latitude (DD)’)
zlabel(‘Amplitude (db)’)
title(‘3D - RF Environment Raw Data (Latitude, Longitude, Amplitude)’)
% Figure 5 plot
plot(Longitude,Latitude,‘*’); hold on; grid on
plot(Long_Amp_Max{1},Lat_Amp_Max{1},‘x’)
xlabel(‘Longitude’)
ylabel(‘Latitude’)
title(‘Data Path / Max Amplitude Displayed’)
% Figure 6 plot
[c,h] = contourf(xi,yi,zi{1},20,‘ShowText’,‘off’); hold on;
F = getframe(gca);
imwrite(F.cdata, naming_tif,‘Resolution’,300);
plot(xi,yi,‘o’); hold on
plot(Longitude,Latitude,‘-’,‘LineWidth’,3); hold on
plot(Long_Amp_Max{1},Lat_Amp_Max{1},‘x’,‘MarkerSize’,15,...
    ‘LineWidth’,3); hold on
scatter(Ckm(:,1),Ckm(:,2),‘kx’,‘LineWidth’,3); hold off
  %set(gca,‘color’,‘none’);
grid on; colorbar
axis([West East South North])
xlabel(‘Longitude’)
ylabel(‘Latitude’)
title(‘2D - RF Environment Heat Map (Latitude, Longitude)’)
% Figure 7 plot
s=surf(xi,yi,zi{col_freq}); grid on; colorbar; hold on
scatter3(Ckm(:,1),Ckm(:,2),Ckm(:,3),‘kx’,‘LineWidth’,3); hold off
s.EdgeColor = ‘interp’;
xlabel(‘Longitude (Decimal Degrees)’)
ylabel(‘Latitude (Decimal Degrees)’)
zlabel(‘Amplitude(db)‘)
title(‘3D - RF Environment Heat Map (Latitude, Longitude, Amplitude)’)
% Figure 8 plot
scatter3(xi_km,yi_km,zi_km,15,idx_km,‘filled’); hold on
scatter3(Ckm(:,1),Ckm(:,2),Ckm(:,3),‘kx’,‘LineWidth’,3); hold off
xlabel(‘Longitude (Decimal Degrees)’)
ylabel(‘Latitude (Decimal Degrees)’)
zlabel(‘Amplitude(db)’)
title(‘3D - Kmeans Clustering (Latitude, Longitude, Amplitude)’)
```

Additionally, a GeoTiff and KML File Naming Convention may implemented. In some aspects, a portion of the code shown in TABLE 7 below creates a display plot for a user to name and define a GeoTiff and KML files that will be produced in a next or subsequent sub-block of code.

TABLE 7
prompt_File = {‘Naming Convention GeoTif’,‘Naming Convention
KML’} ;
dlgtitle_File = ‘Naming GeoTif & KML Files’;
dims = [1 60; 1 60]; definput = {‘GeoTif File Name’,‘KML File Name’};
File_Selection = inputdlg(prompt_File,dlgtitle_File,dims,definput);
naming_tif=strcat(‘Contour’,File_Selection{1},‘.tif’);
naming_kml=strcat(‘Contour’,File_Selection{2},‘.kml’);

One of the goals of the present methodology is to identify the location of an unknown emitter(s). Based on the information above, the contour plot generated in FIG. 6, for example, may be converted into a Tagged Image File Format (.Tif), which is a high-quality graphics format. This format is often used for storing images with many colors, such as in the case of digital photos. In the present case, the Tif utilizes information from the contour generation produced (See e.g., FIG. 6) to create a .Tif that can be imported into Google Earth, for example. One exemplary code for accomplishing this importation, including exporting and/or creating the GeoTiff and KML files, is shown in TABLE 8 shown below.

```
TABLE 8
imwrite(F.cdata, naming_tif,‘Resolution’,300);
% The second part of this code is to produce a kml file.
% The information below is specific to an
% algorithm developed from the following person/location: D. C. Hanselman,
% University of Maine, Orono, ME 04469
% Please note the following pseudocode to understand the variables being
% pulled from the Contour variable.
        % CONTOUR, CONTOURF, CONTOUR3, and CONTOURC all produce a contour
        % matrix C that is traditionally used by CLABEL for creating contour
        % labels.
%
        % S = CONTOURDATA(C) extracts the (x,y) data pairs describing each
        % contour line and other data from the contour matrix C. The vector
        % array structure S returned has the following fields;
%
& S(k).level contains the contour level height of the k-th line.
% S(k).numel contains the number of points describing the k-th line.
% S(k).isopen is True if the k-th contour is open and False if it is closed %
S(k).xdata contains the x-axis data for the k-th line as a column vector
% S(k).ydata contains the y-axis data for the k-th line as a column vector
nlevels=100;
if ~isfloat(c) || size(c,1)~=2 || size(c,2)<4
  error(‘CONTOURDATA:rhs’,...
        ‘Input Must be the 2-by-N Contour Matrix C.’)
end
tol=1e−12; k=1; % contour line number
col=1; % index of column containing contour level and number of points
while col<size(c,2) % while less than total columns in c
    cs(k).level = c(1,col);
    cs(k).numel = c(2,col);
    idx=col+1:col+c(2,col);
    cs(k).xdata = c(1,idx).‘;
    cs(k).ydata = c(2,idx).’;
    cs(k).isopen = abs(diff(c(1,idx([1 end]))))>tol || ...
          abs(diff(c(2,idx([1 end]))))>tol;
    k=k+1;
    col=col+c(2,col)+1;
end
[cs.Lat] = cs.ydata;
[cs.Lon] = cs.xdata;
cs = rmfield(cs, {‘xdata’, ‘ydata’});
g = geoshape(cs);
[~, ~, levidx] = unique(g.level);
cmap = parula(nlevels);
kmlwrite(naming_kml, g, ‘Color’, cmap(levidx, :),...
      ‘AltitudeMode’, ‘clampToGround’);
```

The present disclosure also features advanced calculations for determining RF emitter locations, and such calculations are one of the more significant unique features of the presently disclosed methodology. As an analogy of these calculations, a simple example scenario is instructive. In this scenario, imagine standing in front of a table. A cup of boiling water is randomly set on the table (i.e., akin to an unknown transmitter in the present application). Eventually the area around the cup (assuming the cup is not good at retaining heat) will begin to make its surroundings hot. In this scenario, imagine how would one find the cup if they were blindfolded. Most likely, one would sense for the cup/heat by physical touch (i.e., this searching/sensing being akin to a receiver searching for RF emission amplitudes in the present application). Notwithstanding, in the scenario of the blindfolded searcher, it is possible to make finding the hot cup on the table easier by randomly placing ice cubes on the table (i.e., representing cold amplitude zones). In this scenario, a searcher would be able to more quickly find the cup (i.e., an RF transmitter in the present application) because a larger variance now exists between the temperatures that make finding the hot cup easier. This example scenario is directly analogous to the present methodology of finding RF emitters in the RF domain. The recorded data affords understanding “cold zones” in conjunction with the “hot zones.” When the receiver (i.e., akin to the blindfolded searcher's hand on the table) is moving around in an operational domain, the present method can process the amplitude data to correlate the information to locate the “hot zone” easier. Furthermore, the presently disclosed methods and code are optimized to strategically choose boundaries that will find an emitter location with minimal data processing. That is, if one processed all the recorded data points, this would result in calculating billions of data points. Instead, the present method affords the ability to strategically choose a few locations to quickly identify the location(s) RF emitters.

Further to the methodology discussed above, examples of a code to implement the advanced calculations are shown in TABLES 9A and 9B below.

TABLE 9A
% The code will automatically choose X number of data points from the recoded data set.
% The code will then begin calculating the Distance from Recorded Data Points to each
% of the Grid Points. Currently, the code is setup to choose the Maximum, Average,
% and Minimum recorded amplitude values. These will be the boundary conditions, depending
% on the desired fidelity of the results, a user will be prompted to choose X number of
% recorded data points for which to calculate a distance matrix. This number will
% be evenly distributed between the boundary conditions, shown below,

| | |
|---|---|
| % Maximum | Recorded dB - Lat, Long |
| % \| | Recorded dB - Lat, Long |
| % Average | Recorded dB - Lat, Long |
| % \| | Recorded dB - Lat, Long |
| % Minimum | Recorded dB - Lat, Long |

% For this code to work as intended there needs to be a minimum of five
% data recorded data points selected, however, any additional data points
% will increase the fidelity, which will also create a higher resolution
% heat map of the RF environment.
% The code below sorts the rows based on the amplitude measurements to
% pull the correct information described above.
Rec_Data = [Latitude, Longitude,Amp(:,col_freq)];
Rec_Data_Sorted = sortrows(Rec_Data,3);
% Resolution Points = Res_Points
% Once the points have been sorted the code below will pull the correct
% values from the recorded data set. The code will than begin calculating
% the Distance from the Recorded Data Points to each of the Grid Points.

TABLE 9B
% Break down of the Distance Calculations
% To derive law of Haversine one needs to start the calculation with
% spherical law of cosine i.e., cos a = cos(b)*cos(c)+sin(b)*sin(c)*cos(A).
% One can derive Haversine formula to calculate distance between two as:
% a = sin²(latDifference/2) + cos(lat1)*cos(lat2)*sin²(lonDifference/2)
% c = 2*atan2(sqrt(a), sqrt(1−a))
% d = R*c
where,

| | |
|---|---|
| % | latDifference = lat1 − lat2 (difference of latitude) |
| % | lonDifference = lon1 − lon2 (difference of longitude) |
| % | R is radius of earth i.e., 6371 KM or 3961 miles |
| % | and d is the distance computed between two points. |

```
%--------------------------------------------------------------------------
% The number that is dividing this item “round(0:length(Rec_Data_Sorted)”
% determines the number of points selected from the recorded data to be processed.
% Do not increase this number beyond 10, depending on how many recorded data points
% you have and the spacing of your grid mesh as you could end up calculating
%billions/trillions of data points that will cause your computer to seize up.
Res_Points=round(0:length(Rec_Data_Sorted)/7:length(Rec_Data_Sorted),0);
Res_Points(1)=1; R=6371E3; % radius of the earth meters
for i=1:1:length(Res_Points)
  Phi1(i) = Rec_Data_Sorted(Res_Points(i),1); %Lat of Rec Point
  Lamda1(i)=Rec_Data_Sorted(Res_Points(i),2); %Lon of Rec Point
  Phi1_cov(i) = deg2rad(Rec_Data_Sorted(Res_Points(i),1)); &Lat Rec Point
  Lamda1_cov(i) =deg2rad(Rec_Data_Sorted(Res_Points(i),2)); %Lon Rec Point
  P_rcvd(i)=Rec_Data_Sorted(Res_Points(i),3); & Amp of Rec Point
  for j=1:1:size(xi,1)
```

```
  for q=1:1:size(xi,2)
  Phi2{i}(j,q)=yi(j,q); % Lat of Grid Point
  Lamda2{i}(j,q)=xi(j,q); % lon of Grid Point
  Phi2_cov{i}(j,q)=deg2rad(yi(j,q)); & Lat of Grid Point
  Lamda2_cov{i}(j,q)=deg2rad(xi(j,q)); % lon of Grid Point
  Delta_Phi{i}(j,q)=deg2rad(Phi2{i}(j,q)-Phi1(i));
  Delta_Lamda{i}(j,q)=deg2rad(Lamda2{i}(j,q)-Lamda1(i));
  haversine{i}(j,q)=sin((Delta_Phi{i}(j,q))/2).\hat{ }2+...
    cos(Phi1_cov(i))*cos(Phi2_cov{i}(j,q))*...
    sin((Delta_Lamda{i}(j,q))/2).\hat{ }2;
  unscalled{i}(j,q)=2*atan2(sqrt(haversine{i}(j,q)),...
    sqrt(1-haversine{i}(j,q)));
  Dist_Rec_Grid{i}(j,q)=R*unscalled{i}(j,q);
  % The P_Txtr will calculate the required power to needed in relation %
  to the distance calculation to achieve the recorded data points
  % amplitude. This equation is the Free Space Loss Equation
  % rearranged to solve for the transmitted power. If you have
  % ‘intelligence’ on the system you are trying to identify you could
  % take the equation one further to include the maximum transmit
  % power. This would further increase your numbers, however, for all
  % of our tests we assumed we had no information about the emitter.
  P_Txtr{i}(j,q)=P_rcvd(i)+21.98-...
      20*log10(physconst(‘LightSpeed’)/Freq_Hz)+...
      20*log10(Dist_Rec_Grid{i}(j,q));
  end
```

end
end

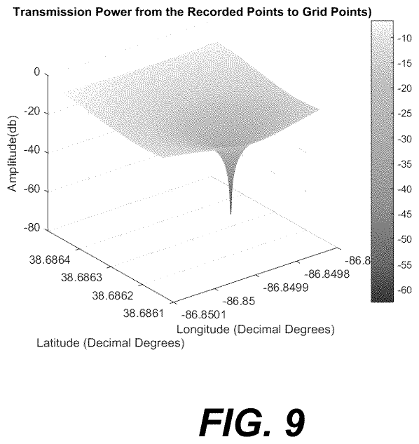

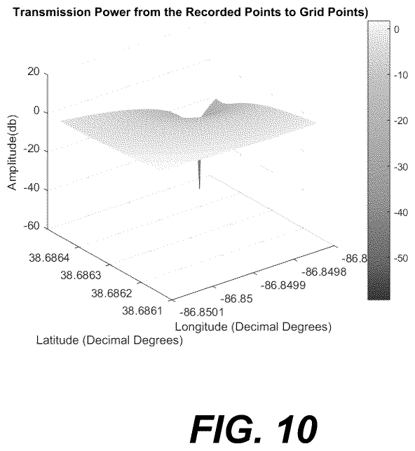

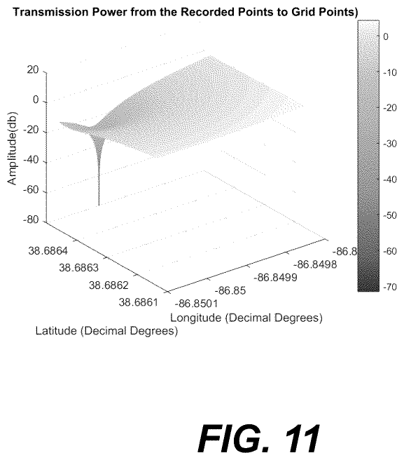

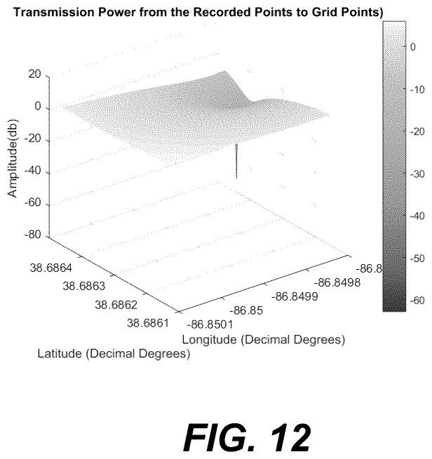

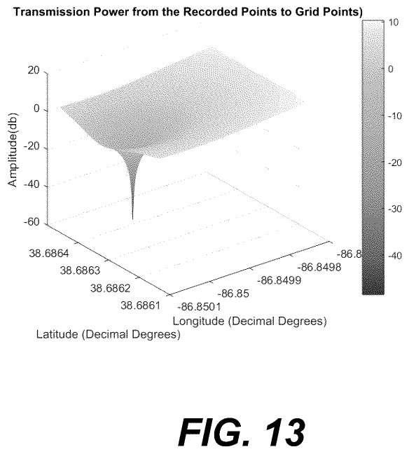

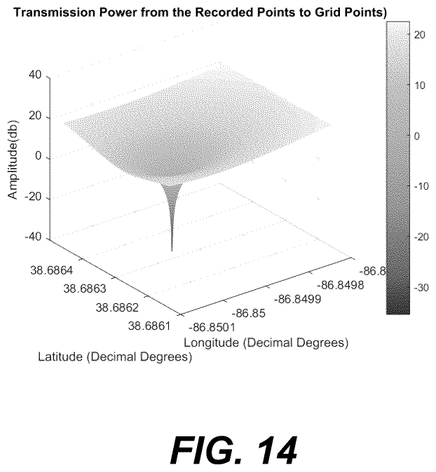

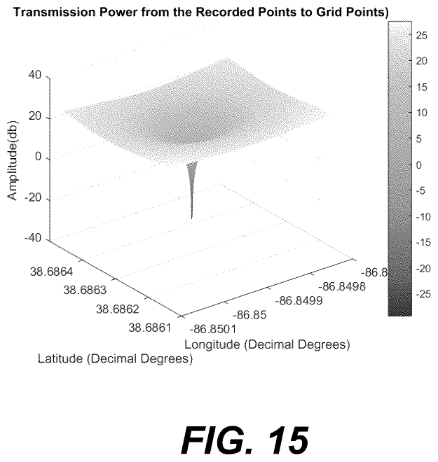

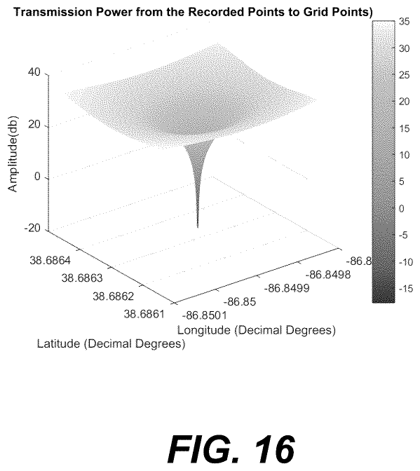

FIGS. 9-16 illustrate various three-dimensional plots of transmission power from recorded points to grid points over latitude, longitude, and amplitude readings according to aspects of the present disclosure. In particular aspects, FIGS. 9-16 are 3D plot representations of the longitude versus latitude versus the signal amplitude measured (e.g., measured by the SDR such as 104 in FIG. 1). These plots are specifically showing the transmission power required at each of the mesh grid points to achieve the recorded amplitude. It is noted that the recorded amplitude values and the mesh grid do not align perfectly and, thus, a value of 0 dB will not be shown on the plot, but nonetheless may be close to absolute.

An example of the code that may be used to plot FIGS. 9-16 (i.e., FIG. 8+i for values of i=1 to 8 given the particular figure numbering, but those skilled in the art will realize this is arbitrary and not limited to particular numbering or even to using figure numbering) is illustrated in TABLE 10 below.

TABLE 10
for i=1:1:8 figure(8+i)
s=surf(xi,yi,P_Txtr{i}); colorbar; hold on
s.EdgeColor = ‘interp’;
xlabel(‘Longitude (Decimal Degrees)’)
ylabel(‘Latitude (Decimal Degrees)’)
zlabel(‘Amplitude(db)’)
title(‘Transmission Power from the Recorded Points to Grid Points)’)
end

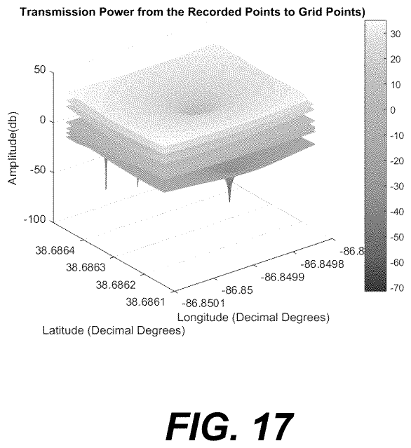

FIG. 17 shows another three-dimensional plot of transmission power from recorded points to grid points over latitude, longitude, and amplitude readings according to aspects of the present disclosure. In particular aspects, the plot in FIG. 17 illustrates the combination of FIGS. 9-16 into one plot. This plot illustrates the required power from each of the recorded amplitude points. All of these points may be plotted together and utilize advanced calculus to determine a 3D geometrical equation for each of the plots (i.e., FIGS. 9-16) and then calculate their intersections. This affords the immediate determination of the emitter location, but is extremely computationally intensive.

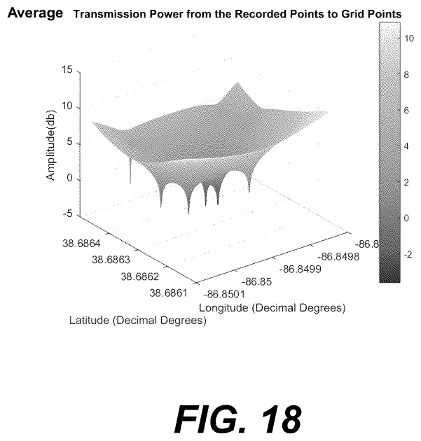

FIG. 18 shows a three-dimensional plot of average transmission power from recorded points to grid points over latitude, longitude, and amplitude readings according to aspects of the present disclosure. In some aspects, the FIG. 18 plotting involves performing an averaging plot more strategically to choose the points to produce a high zone. The transmitter will be in a null to cause the recorded points to be in a lower zone thus producing a high zone where the transmitter is located.

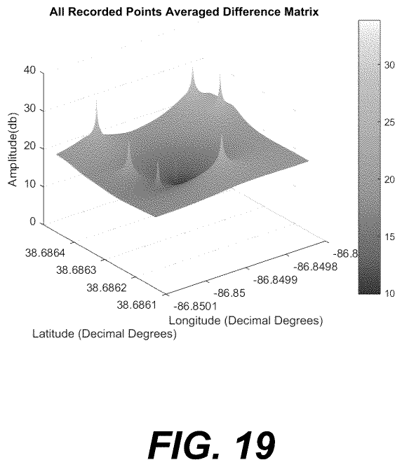

FIG. 19 shows a three-dimensional plot of an all recorded points averaged difference matrix over latitude, longitude, and amplitude readings according to aspects of the present disclosure. In particular aspects, FIG. 19 illustrates the final RF operational environment plot designed to show the 3-dimensional space of where the emitter is located. This plot will have the transmitter located at the minima Z point due to the normalization of the comparison matrix. These results can then be compared to FIG. 18, which theoretically will be an inverse representation of the amplitude. The results can also be compared to the initial condition data and the clustering technique to obtain a comprehensive picture of the various emitters' locations.

In an example, the following TABLES 11 and 12 show an exemplary coding that can be utilized to plot FIGS. 17 and 18 (See e.g., TABLE 11), and FIG. 19 (See e.g., TABLE 12).

```
TABLE 11
figure(17) for i=1:1:8
s=surf(xi,yi,P_Txtr{i}); colorbar; hold on
s.EdgeColor = 'interp';
xlabel('Longitude (Decimal Degrees)')
ylabel('Latitude (Decimal Degrees)')
zlabel('Amplitude(db)')
title('Transmission Power from the Recorded Points to Grid Points)')
end
hold off
%-----------------------------------------------------------------------------------------------------------------
% Re-enable this line to do the averaging plot
% more strategically choose the points to produce a high zone. The
% transmitter will be in a null to cause the recorded points to be in a
% lower zone thus producing a high zone where the transmitter is located.
P_Txtr_High=((P_Txtr{1}+P_Txtr{2}+P_Txtr{3}+P_Txtr{4}+P_Txtr{5}+P_Txtr{6}+P_Txtr{7}+P_Txtr{8})/8);
figure(18)
s=surf(xi,yi,P_Txtr_High); colorbar; hold on
s.EdgeColor = 'interp'
;xlabel('Longitude (Decimal Degrees)')
ylabel('Latitude (Decimal Degrees)')
zlabel('Amplitude(db)')
title('Average Transmission Power from the Recorded Points to Grid Points')
%-----------------------------------------------------------------------------------------------------------------
% Depending on the number of points the user selected from the recorded data to analyze (<10)
% P_Txtr will be broken down into the % following format:
% A B C D E ... N
% ------------------------------------------------------------------------------------------------------
% P_Txtr = MxN   MxN  MxN   MxN  MxN   MxN   MxN %
% ------------------------------------------------------------------------------------------------------
% This portion of the code will than leverage a Power Transmission comparison
% Matrix. It is following the format depicted below:
%  | Col1   Col2   Col3   ColN |
%  ----------------------------------------------------
%   |A-A|   |A-B|  |A-C|  |A-N| |
%  |x   |B-C|  |B-D|  |B-N| |
% P_Txtr_Avg=  |x  x  |C-D|  |C-N| |
%  |x  x  x  |D-N| |
%  |x  x  x  x |
% All of the sub-matrixes in the P_Txtr_Avg are added together and averaged
% to produce a single matrix. This matrix allows us to directly compare
% all of the required transmission powers together to get a comprehensive
% intensity plot.
Matrix_Solve_Out=cell(1,(length(P_Txtr)*(length(P_Txtr)-1))/2);
n=1;
for i=1:1:length(P_Txtr)-1
  for ii=i+1:1:length(P_Txtr)
  Matrix_Solve{i,ii}=abs(P_Txtr{i}-P_Txtrfii});
  Matrix_Solve_Out{n} = Matrix_Solve{i,ii};
  n=n+1;
  end
end
```

TABLE 12
Average_Pxtr=sum(cat(3,Matrix_Solve_Out{:}),3);
figure(19)
s=surf(xi,yi,Average_Pxtr/length(Matrix_Solve_Out)); colorbar; hold on
s.EdgeColor = ‘interp’;
xlabel(‘Longitude (Decimal Degrees)’)
ylabel(‘Latitude (Decimal Degrees)’)
zlabel(‘Amplitude(db)’)
title(‘All Recorded Points Averaged Difference Matrix’)

In yet further aspects, the method for K-means clustering determination may be as follows. First, the k-means algorithm iteratively minimizes the distance between every data point and its centroid to find the most optimal solution for all of the data points. Initial Variables include the following: k=Number of clusters, n=number of cases, Xᵢ^{(j)}=point location Cⱼ=centroid for cluster, ∥Xᵢ^{(j)}−Cⱼ∥²=Eucledian Distance between point (Xᵢ^{(j)}) and centroid (Cⱼ). The first format of this algorithm employs an equation using the Euclidian Distance as depicted in Equation 1.

J=Σᵢ₌₁^{k}Σⱼ₌₁ⁿ(∥Xᵢ^{(j)}−Cⱼ∥²) (1)

With regard to optimizing the K-means function via a silhouette method, it can be assumed that the data has already been clustered into k clusters via the k-means methodolgoy. The silhouette method will output the optimal number of clusters (s(i)) via the unsupervised learning algorithm.

Here initial variables are as follows: C(i)=cluster assigned to the i^{th} data point, and |C(i)|=number of data points in the cluster assigned to the i^{th} data point. The following Equation 2 calculates a(i), which gives a measure of how well the assigned i^{th} data point is to its cluster.

$$a ( i ) = \frac{1}{\vert C ( i ) \vert - 1} {\sum }_{C ( i ) , i \neq j} d ( i , j ) \qquad ( 2 )$$

Equation 3 below provides for calculating a variable b(i), which defines the average dissimilarity to the closest cluster that is not within its cluster.

$$b ( i ) = {min}_{i \neq j} ( \frac{1}{\vert C ( i ) \vert} {\sum }_{j ∈ C ( j )} d ( i , j ) ) \qquad ( 3 )$$

Equation 4 below represents that all of the information is then fed into this equation to determine the silhouette coefficient (i.e., the optimal number of clusters based on the input data).

$$s ( i ) = \frac{b ( i ) - a ( i )}{max ( a ( i ) , b ( i ) )} \qquad ( 4 )$$

The equation (4) above is a condensed form of the formal Equation 5 as follows:

$$s ( i ) = \frac{{min}_{i \neq j} ( \frac{1}{\vert C ( i ) \vert} {\sum }_{j ∈ C ( j )} d ( i , j ) ) - \frac{1}{\vert C ( i ) \vert - 1} {\sum }_{C ( i ) , i \neq j} d ( i , j )}{max ( \frac{1}{\vert C ( i ) \vert - 1} {{\sum }_{C ( i ) , i \neq j}}_{} d ( i , j ) , {min}_{i \neq j} ( \frac{1}{\vert C ( i ) \vert} {\sum }_{j ∈ C ( j )} d ( i , j ) ) )} \qquad ( 5 )$$

In other aspects, the following gives an example of advanced calculations that may be used in present methodology.

Calculating the Great-Circle Distance between Two Points

In this case, the Initial Variables are as follows: φ1=Latitude Point 1 (Radians), φ2=Latitude Point 2 (Radians), λ1=Longitude Point 1 (Radians), λ2=Longitude Point 2 (Radians), R=6.371×10³ (Earth Radius Meters). A central angle θ between any two points on a sphere is represented by the following Equation 6 below:

θ=d/R (6)

where d is the distance between the two points along a great circle and r is the radius of the sphere (i.e., the Earth).

Next, the Haversine formula allows the Haversine of θ to be computed directly from the latitude (represented by φ) and longitude (represented by λ) of the two points using the following equation (7):

hav(θ)=hav(φ2−φ1)+cos(φ1)cos(φ2)hav(λ2−λ1) (7)

where lambda λ and phi φ are represented by the appropriate latitude and longitude values.

Further, the Haversine function can be applied to both the central angle θ and the difference in latitude and longitude according to Equation 8 as follows:

hav(θ)=sin²(θ/2)=(1−cos(θ))/2 (8)

Moreover, the Haversine function can reduce Equation 8 into to a more manageable equation, shown below for calculations within MATLAB.

Equation 9 below is the square of half the cord length between the points.

a=sin2(Δφ/2)+cos(φ1)*cos(φ2)*sin2(Δλ/2) (9)

Equation 10 solves for the distance d, which applies the archaversine (inverse) to h=hav(θ). The Equation 10 provides the angular distance in radians.

$$c = 2 * {sin}^{- 1} ( \sqrt{{sin}^{2} ( \frac{Δφ}{2} ) + cos {φ}_{1} * cos {φ}_{2} * {sin}^{2} ( \frac{Δ λ}{2} )} ) \qquad ( 10 )$$

If a user is utilizing MATLAB, in particular, to calculate the angular distance they may use a variance of Equation 10 expressed as Equation 11 shown below:

$$c = 2 * atan 2 ( ( \sqrt{{sin}^{2} ( \frac{Δφ}{2} ) + cos {φ}_{1} * cos {φ}_{2} * {sin}^{2} ( \frac{Δ λ}{2} )} ) , ( 1 - \sqrt{{sin}^{2} ( \frac{Δφ}{2} ) + cos {φ}_{1} * cos {φ}_{2} * {sin}^{2} ( \frac{Δ λ}{2} )} ) ) \qquad ( 11 )$$

Next, the distance may be scaled based on the radius of the sphere (i.e., Earth), in order to accomplish this scaling, the angular distance in radians is multiplied with the radius in meters via Equation 12 below:

d=R*c (12)

This product provides the distance between two latitude/longitude values in meters.

Creating a Distance Matrix from the Recorded Data and Generated Grid Points

Additionally, a distance matrix may be created using the recorded data and the generated grid points. The first part to setting up the distance matrix is calculating the maximum and minimum latitude/longitude values from the recorded dataset according to the following relationships.

φmax=maxiϵ|n|f Rec φ(i)

φmin=miniϵ|n|f Rec φ(i)

λmax=maxiϵ|n|f Rec λ(i)

λmin=miniϵ|n|f Rec λ(i)

where, φ=Latitude, and λ=Longitude.

Once the maximum and minimum values are determined for the recorded dataset, a mesh grid matrix may be produced. In particular, an N by N matrix is created from the minimum to the maximum values for each of latitude and longitude mesh matrices as illustrated below.

$${Latitude}_{Mesh} = xi = [ \begin{matrix}φmin & ⋯ & {φ}_{n + 1} & ⋯ & φmax \\ ⋮ & ⋱ & & & ⋮ \\ φmin & ⋯ & {φ}_{n + 1} & & φmax \\ ⋮ & & & ⋱ & ⋮ \\ φmin & ⋯ & {φ}_{n + 1} & ⋯ & φmax\end{matrix} ]$$

$${Longitude}_{Mesh} = yi = [ \begin{matrix}λmin & ⋯ & λmin & ⋯ & λmin \\ ⋮ & ⋱ & & & ⋮ \\ {λ}_{n + 1} & ⋯ & {λ}_{n + 1} & & {λ}_{n + 1} \\ ⋮ & & & ⋱ & ⋮ \\ λmax & ⋯ & λmax & ⋯ & λmax\end{matrix} ]$$

Next, the method may utilize a preselected number (e.g., typically 5-8) of the recorded data points and calculate the distance between the recorded values and the Latitude/Longitude mesh grid. This iterative process utilizes the haversine calculations shown in the section above entitled “Calculating the Great-Circle Distance between Two Points” and utilizes the following relationships for an M×N distance matrix.

$${D}_{Matrix} = [ \begin{matrix}{d}_{{φ}_{1} , {λ}_{1} \to {φ}_{2} , {λ}_{2}} & ⋯ & {d}_{{φ}_{1} , {λ}_{1} \to {φ}_{N} , {λ}_{N}} \\ ⋮ & ⋱ & ⋮ \\ {d}_{{φ}_{1} , {λ}_{1} \to {φ}_{N} , {λ}_{N}} & ⋯ & {d}_{{φ}_{1} , {λ}_{1} \to {φ}_{N} , {λ}_{N}}\end{matrix} ] ,$$

where d=haversine equation

The matrix above is identical to the matrix shown below, except that the matrix below shows the haversine calculations in at least the first cell, for example, to illustrate the calculations being executed from the haversine calculations.

$${D}_{Matrix} = [ \begin{matrix}2 * R * atan 2 ( ( \sqrt{{sin}^{2} ( \frac{Δφ}{2} ) + cos {φ}_{1} * cos {φ}_{2} * {sin}^{2} ( \frac{Δ λ}{2} )} ) \cdot ( 1 - \sqrt{{sin}^{2} ( \frac{Δφ}{2} ) + cos {φ}_{1} * cos {φ}_{2} * {sin}^{2} ( \frac{Δ λ}{2} )} ) ) & ⋮ & {D}_{{φ}_{1} , {λ}_{1} \to {φ}_{N} , {λ}_{N}} \\ ⋮ & ⋱ & ⋮ \\ {D}_{{φ}_{1} , {λ}_{1} \to {φ}_{N} , {λ}_{N}} & ⋮ & {D}_{{φ}_{1} , {λ}_{1} \to {φ}_{N} , {λ}_{N}}\end{matrix} ]$$

Calculating Required Transmission Power from the Recorded Data Points in Relation to the Distance Matrix

Additionally, a required transmission power may be calculated from the recorded data point in relation to the distance matrix discussed above. In these calculations, the initial variables are as follows:
c=speed of Light;
f=Selected Frequency (Hz);
d=distance matrix index;
P_{Rcvd}=Amplitude Power Received (dB);
P_{Txtr}=Amplitude Power Transmit (dB); and
X=Chosen number of Recorded Data Points.

A Transmit Power Matrix (Ptxtr) is used calculate the required power needed in relation to the distance calculation to achieve the recorded data points amplitude. This equation is the Free Space Loss Equation re-arranged to solve for the transmitted power. This matrix allows determination of a required Transmit Power Matrix that is dependent on the latitude and longitude data as follows:

$$Ptxtr Matrix ( X ) = Transmit Power Matrix ( dB ) = [ \begin{matrix}{P}_{Txtr ( 1 , 1 )} & ⋯ & {P}_{Txtr ( 1 , N )} \\ ⋮ & ⋱ & ⋮ \\ {P}_{Txtr ( N , 1 )} & ⋯ & {P}_{Txtr ( N , N )}\end{matrix} ]$$

$$where ,$$

$$Ptxtr ( n , n ) = {P}_{Rcvd} + 21.98 - 20 {log}_{10} ( \frac{c}{f} ) + 20 {log}_{10} ( D {Matrix}_{N , n} ) .$$

The output of the Ptxtr matrix will produce X number of Power matrices in the following format. Ptxtr Matrix=[Ptxr1 . . . PtxrN].

### Power Transmission Comparison Matrix

The following calculations are designed to place the transmitter into a null. In particular aspects, a power transmission comparison matrix is implemented to compare all of the power matrixes to produce an average transmission power plot according to the following relationship:

$$Ptxtr Average = [ \begin{matrix}\vert {P}_{txtrMatrix 1} - {P}_{txtrMatrix 1} \vert & \vert ⋯ \vert & \vert {P}_{txtrMatrix 1} - {P}_{txtrMatrix N} \vert \\ & \vert {P}_{txtrMatrix 2} - {P}_{txtrMatrix 3} \vert & \vert {P}_{txtrMatrix 2} - {P}_{txtrMatrix N} \vert \\ & & \vert {P}_{txtrMatrix 3} - {P}_{txtrMatrix N} \vert\end{matrix} ]$$

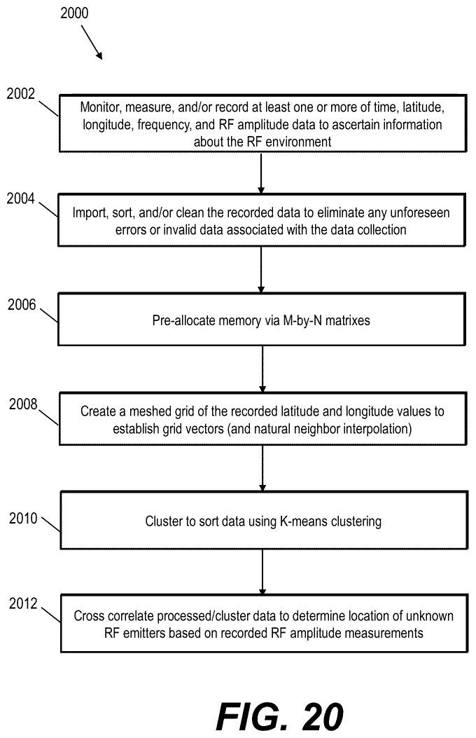

FIG. 20 shows a flow diagram of one exemplary method 2000 for determining RF emitter locations according to some aspects of the disclosure. At block 2002, data is monitored, measured, and/or recorded including time, latitude, longitude, frequency, and RF amplitude data to ascertain information about the RF environment. In an aspect, the RF amplitude measurements may be effectuated using the Software Defined Radio (SDR) 104, and/or the SDR 104 in combination with the process 102 and/or memory 103. The recorded data is then processed including importing, sorting, and cleaning the data to eliminate any unforeseen errors or invalid data associated with the data collection during the processes of block 2002 as shown in block 2004. In an example, to eliminate unforeseen or invalid data of the collected RF information. In an example, the processes of block 2004 may include processes described above in connection with TABLE 2.

Once the data has been processed, the method 2000 may include pre-allocating memory (e.g., memory 103 as one example) via M-by-N matrixes as shown at block 2006 (and which may determined during or concomitant with the importing/sorting/cleaning phase of block 2004) to eliminate excess computational time. Next, method 2000 includes creating a meshed grid of the recorded latitude and longitude values to establish grid vectors as shown at block 2008. This mesh creation creates a boundary condition that is leveraged to produce the coordinates of a rectangular grid (X, Y) based on the maximum/minimum recorded Latitude/longitude values. The grid data, in conjunction with the Latitude, Longitude, and RF Amplitude values, are then imported into a natural neighbor interpolation function. The interpolation function allows the script to calculate realistic data at each of the grid vectors based on the recorded dataset (i.e. increasing the number of points within the dataset to get higher fidelity). The interpolation function creates a mesh grid (X-Latitude, Y-Longitude) with an intensity value (Z-Amplitude) to produce a 2-Dimensional and 3-Dimensional representation of the recorded data. In some aspects, it is noted that the processes of block 2002 through 2008 are initial conditions and calculations that are useful for setting up the remaining processes of method 2000 to then ascertain the locations of unknown emitters via the RF amplitude measurements.

Once the initial conditions have been calculated the script then utilizes a k-means clustering algorithm to further sort the data as shown at block 2010. In aspects, the clustering process or algorithms are designed to help determine “hot” spots within the dataset (i.e., clusters or zones in which the amplitude is similar across a 3-Dimensional space). In further aspects, the k-means clustering algorithm color coordinates the data into distinctive clusters (e.g., pre-set to only compute five clusters, but not limited to such number) and calculates each of the clusters' centroid. The centroid is then plotted on a 2D and 3D plot to help ascertain an emitter's location. The centroid provides a user with a confidence interval on where the unknown emitter is located, however, this is a rudimentary method of determining the exact location. The centroids are then plotted against the initial intensity plots (i.e. the initial conditions or recorded data) to cross-correlate the data to see if there are any trends. This typically results in one or two zones in which the emitter may be located within.

The method 2000 here employs advanced and innovative calculation schemes to ascertain the unknown emitter location. Due to memory constraints, the method 2000 implements a methodology or structure that strategically selects or chooses X number of recorded data points (e.g., 5-10, but not limited to such). These data points consist of the minimum, average, and maximum amplitude values (with their corresponding latitude and longitude information) and randomly selected data points in between these boundary conditions. These points are then used to create X number of M-by-N distance matrixes. These distance matrixes use the law of haversine to calculate the selected data points distance between the mesh grids (i.e. latitude and longitude boundary conditions) calculated in the first phase of the MATLAB script. Once the distances are calculated the Free Space Path Loss (FSPL) equation is utilized to calculate the transmit power needed from the each of the grid points to obtain the received amplitude at the recorded data point. A 3D latitude, longitude, and Required Power surface plot is created for each of the X number of recorded data points. The M-by-N transmit power matrixes are then iteratively subtracted from each other. The absolute is taken of each sub-matrix to negate any negative amplitudes. All of the submatrices are then averaged to produce a single required power transmit plot. The final 3D surface plot will point to the unknown emitter's location. This plot shows the required power to obtain the recorded value across the entire gridded zone, the minimum amplitude (dB) will be the zone in which the emitter is located. This information can then be cross correlated with the clustering algorithm zones and the initial conditions to fully verify that the location of the unknown emitters location as shown at block 2012.

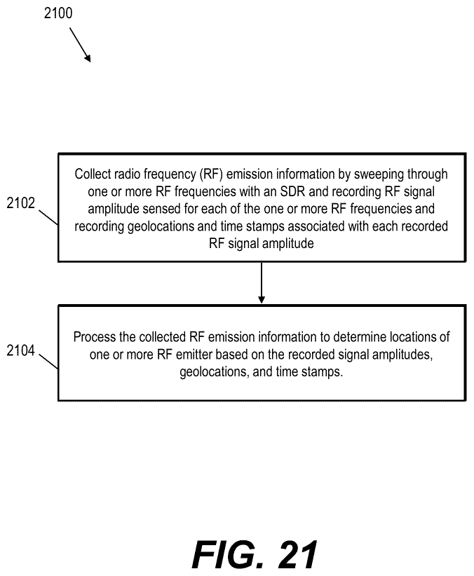

FIG. 21 illustrates a flow diagram of another exemplary method 2100 for determining RF emitter locations according to some aspects of the disclosure. Method 2100 includes collecting radio frequency (RF) emission information by sweeping through one or more RF frequencies with an SDR and recording RF signal amplitude sensed for each of the one or more RF frequencies and recording geolocations and time stamps associated with each recorded RF signal amplitude as shown in block 2102. Furthermore, method 2100 includes processing the collected RF emission information to determine locations of one or more RF emitter based on the recorded signal amplitudes, geolocations, and time stamps as shown in block 2104.

In summary, it is noted that the present apparatus and methods reduce the number of hardware peripherals (i.e. receivers) required to determine an emitter's location. Additionally, the technology/software may be produced utilizing commercial off the shelf technology/software, although not limited to such. Furthermore, the present apparatus and methods have minimal size, weight, and power requirements making the system portable, light, and easy to implement onto any platform.

In further aspects, it is noted that the processor 102 and/or SDR 104 in FIG. 1 may be configured for managing and executing general processing, including the execution of software stored on the computer-readable medium 103. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 102, causes the processing system 100 to perform the various functions described above for any particular apparatus. The computer-readable medium and/or memory 103 may also be used for storing data that is manipulated by the processor 102 when executing software.

The computer-readable medium 103 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 103 may reside in the processor 102 and/or SDR 104, external to the processor 102 or SDR 104, or distributed across multiple entities including the system 100. The computer-readable medium 103 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system. In some further aspects, the computer-readable medium such as 103 contains instructions that may cause the processor 102 and/or SDR 104 to implement the methods as described herein including the methods described above in connection with FIGS. 20 and 21.

Moreover, the present apparatus and methods execute sophisticated calculations to determine RF emitter locations within seconds (after the data is collected) based solely on amplitude measurements. Additionally, the present apparatus and methods can rapidly increase the fidelity of the results by networking multiple devices together. Moreover, the present apparatus and methods have been shown to produce the best results via random data, which mimics real-world circumstances.

In yet further aspects, the present apparatus and methods may utilize a commercial off the shelf (COTS) Software Defined Radio (SDR) to record Time, Latitude, Longitude, Frequency, and Amplitude data and export that information into a single text document (.txt). This also allows determination of an emitters location based on Amplitude measurements The present innovative features afford determination of the location via initial raw measurement processing, clustering algorithms, and RF environmental predictions via an iterative averaging matrix. Also, the methods and apparatus provide for exporting the information into a 3D visualization environment so the user can obtain situational awareness of the operational environment.

Although the invention has been described in detail with reference to certain preferred embodiments, variations and modifications exist within the spirit and scope of the invention as described and defined herein.

1. An apparatus for determining locations of radio frequency emitters comprising:
at least one software defined radio (SDR) configured to collect radio frequency (RF) emission information by sweeping through one or more RF frequencies and recording RF signal amplitude sensed for each of the one or more RF frequencies and recording geolocations and time stamps associated with each recorded RF signal amplitude; and
at least one processor configured to process the collected RF emission information to determine locations of one or more RF emitters based on the recorded signal amplitudes, geolocations, and time stamps.

2. The apparatus of claim 1, further comprising:
the at least one processor configured to sort and clean the collected radio frequency (RF) emission information to eliminate invalid or erroneous data associated with the collection of the radio frequency (RF) emission information.

3. The apparatus of claim 1, further comprising:
at least one memory device communicatively coupled to the at least one processor, the at least one processor further configured to:
produce at least one meshed grid in the at least one memory device, the at least one meshed grid including the geospatial information including recorded latitude and longitude values to establish grid vectors

4. The apparatus of claim 3, further comprising:
the at least one processor configured to:
determine one or more boundary conditions within the meshed grid to produce coordinates of a rectangular grid (X,Y) based on at least one of maximum and minimum of recorded latitude and longitude values; and
produce at least one of two-dimensional and three-dimensional representations of the collected radio frequency (RF) emission information based the meshed grid.

5. The apparatus of claim 1, further comprising:
the at least one processor configured to process the collected RF emission information by including execution of a k-means clustering process to sort the collected RF emission information to determine one or more clusters or zones in which the RF amplitude is similar across at least one of two-dimensional or three-dimensional space.

6. The apparatus of claim 5, further comprising:
the at least one processor configured to calculate a centroid for each of the one or more clusters or zones; and
determine one of a two-dimensional or three-dimensional plot including the calculated centroid for each of the one or more clusters or zone for assisting determination of a location of the radio frequency emitters.

7. The apparatus of claim 5, further comprising:
the at least one processor configured to cross correlate the one or more clusters or zones with pre-known initial conditions to determine one or more locations of the radio frequency emitters.

8. A method for determining locations of unknown radio frequency (RF) emitters comprising:
collect radio frequency (RF) emission information by sweeping through one or more RF frequencies using at least one software defined radio (SDR) and recording RF signal amplitude sensed for each of the one or more RF frequencies and recording geolocations and time stamps associated with each recorded RF signal amplitude; and
process the collected RF emission information to determine locations of one or more unknown RF emitters based on the recorded signal amplitudes, geolocations, and time stamps.

9. The method of claim 8, further comprising:
sorting and cleaning the collected radio frequency (RF) emission information to eliminate invalid or erroneous data associated with the collection of the radio frequency (RF) emission information.

10. The method of claim 8, further comprising:
determining a meshed grid in at least one memory device, the meshed grid including the geospatial information including recorded latitude and longitude values to establish grid vectors

11. The method of claim 10, further comprising:
determining one or more boundary conditions within the meshed grid to produce coordinates of a rectangular grid (X,Y) based on at least one of maximum and minimum of recorded latitude and longitude values; and
producing at least one of two-dimensional and three-dimensional representations of the collected radio frequency (RF) emission information based the meshed grid.

12. The method of claim 8, further comprising:
processing the collected RF emission information by including execution of a k-means clustering process to sort the collected RF emission information to determine one or more clusters or zones in which the RF amplitude is similar across at least one of two-dimensional or three-dimensional space.

13. The method of claim 12, further comprising:
calculating a centroid for each of the one or more clusters or zones; and
determining one of a two-dimensional or three-dimensional plot including the calculated centroid for each of the one or more clusters or zone for assisting determination of a location of the one or more unknown RF emitters.

14. The method of claim 12, further comprising:
cross correlating the one or more clusters or zones with pre-known initial conditions to determine one or more locations of the radio frequency emitters.

15. A computer-readable medium storing computer executable code, wherein the code when executed by at least one processor causes the at least one processor to:
collect radio frequency (RF) emission information with at least one software defined radio (SDR) for determining locations of one or more unknown RF emitters by sweeping through one or more RF frequencies and recording RF signal amplitude sensed for each of the one or more RF frequencies and recording geolocations and time stamps associated with each recorded RF signal amplitude; and
process the collected RF emission information to determine locations of the one or more unknown RF emitters based on the recorded signal amplitudes, geolocations, and time stamps.

16. The computer-readable medium of claim 15, further comprising code when executed by the at least one processor causes the at least one processor to:
generate a meshed grid in at least one memory device communicatively coupled to the at least one processor, the meshed grid including the geospatial information including recorded latitude and longitude values to establish grid vectors

17. The computer-readable medium of claim 16, further comprising code when executed by the at least one processor causes the at least one processor to:
determine one or more boundary conditions within the meshed grid to produce coordinates of a rectangular grid (X,Y) based on at least one of maximum and minimum of recorded latitude and longitude values; and
produce at least one of two-dimensional and three-dimensional representations of the collected radio frequency (RF) emission information based the meshed grid.

18. The computer-readable medium of claim 15, further comprising code when executed by the at least one processor causes the at least one processor to:
process the collected RF emission information by including execution of a k-means clustering process to sort the collected RF emission information to determine one or more clusters or zones in which the RF amplitude is similar across at least one of two-dimensional or three-dimensional space.

19. The computer-readable medium of claim 18, further comprising code when executed by the at least one processor causes the at least one processor to:
calculate a centroid for each of the one or more clusters or zones; and
determine one of a two-dimensional or three-dimensional plot including the calculated centroid for each of the one or more clusters or zone for assisting determination of a location of the one or more unknown RF emitters.

20. The computer-readable medium of claim 18, further comprising code when executed by the at least one processor causes the at least one processor to:
cross correlate the one or more clusters or zones with pre-known initial conditions to determine one or more locations of the one or more unknown RF emitters.
